(19) United States
(12) Patent Application Publication
(10) Pub. No.: US 2026/0364977 A1
(43) Pub. Date: Nov. 19, 2026

(54) MECHANISM FOR INTERMITTENT INFLATION OF VEHICLE WHEELS

(71) Applicant: COLIVE.APS, Gilleleje (DK)

(72) Inventor: Troels Pedersen, Gilleleje (DK)

(73) Assignee: COLIVE.APS, Gilleleje (DK)

(21) Appl. No.: 19/148,300

(22) PCT Filed: Jan. 15, 2024
(86) PCT No.: PCT/EP2024/050799

§ 371 Date: Jul. 15, 2025

(30) Foreign Application Priority Data
Jan. 15, 2023 (DK) PA202300033
Feb. 2, 2023 (DK) PA202300106

(51) Int. Cl. B60C 23/00; B60C 23/12

(52) U.S. Cl. CPC B60C 23/004; B60C 23/126; B60C 23/133

(57) ABSTRACT

A tire inflation mechanism for intermittent inflation of a vehicle wheel tire, comprising: an active mass configured to change speed or position during change in vehicle wheel speed; and an air pump configured to inflate a tire of the vehicle wheel. A change in speed of the vehicle wheel causes the active mass to build up energy or exert forces that is used to drive the air pump to inflate the tire.

### TECHNICAL FIELD

The preset disclosure relates to the field of vehicle wheel maintenance, specifically focusing on the control of tire pressure for vehicles. The technical domain encompasses mechanisms and systems designed to correct inflation levels of vehicle tires.

### BACKGROUND

The wheels of most vehicles used for transportation of people and goods, have a firm or rigid rim of steel or aluminum, mounted with a soft rubber tire, that is inflatable. Among many properties, the tire helps to distribute the load of the vehicle against the road or driving surface and create needed friction to ensure grip and comfort during movement of the vehicle.

The known rubber tire is inflated with atmospheric air to a certain pressure range or interval, to ensure that the tire keeps its intended shape during operation of the vehicle. Air is filled in and out of the tire through a valve adapted to the rim of the wheel.

The pressure may vary a lot from application to application, but for passenger cars, it may be in the range of 1-4 bar pressure above the normal atmospheric pressure.

During changes of atmospheric pressure or temperature outside the tire, the pressure inside the tire may change. Such changes are due to simple laws of nature.

In addition to this, minor leaks of the tire, and in particular with respect to the tire sealing against the rim and around the inflation valve, may gradually lower the pressure of the air inside the tire.

Exceeding a recommended lower pressure inside the tire may increase driving fuel consumption, unequal wear of the tire and even compromise safety.

Thus, the pressure should ideally always be adjusted to meet a recommended level, or a recommended interval provided by the manufacture of the vehicle or tire. For an operator of the vehicle this may be troublesome or annoying to service.

Most passenger and goods transportation vehicles operating on public roads have a mandatory warning surveillance system build into the inlet/outlet valve of the tire. The system—called Tire Pressure Monitoring System (TPMS)—communicates with the infosystem of the vehicle and helps to inform the operator whenever the pressure in the tire exceeds a lower threshold. The TPMS system may warn the operator of a too low tire pressure, and even identify the exact tire of the vehicle, the operator must manually ensure that the tire pressure is readjusted to specifications.

In addition to this, loading the vehicle with different loads may require change in tire pressure. Thus, a heavy load of e.g. passengers in the back of a passenger car may require an adjustment of the tire pressure. For an operator of a passenger car, tires are among the organs of the car that require most attention throughout the use phase of the car.

It is one purpose of the present disclosure to provide a solution to eliminate the need for an operator to manually refill the tire with compressed air during operation. A further object is to provide such a solution without impacting on the design or complexity of the rest of the vehicle. That is, the tire pressure control system described herein may be retrofitted to existing vehicles in a quick and easy way.

Furthermore, other desirable features and characteristics of the present invention will become apparent from the subsequent detailed description and the appended claims, taken in conjunction with the accompanying drawings and the foregoing technical field and background.

### SUMMARY

The present disclosure provides a mechanism for intermittent inflation of a wheel comprising a tire with air.

In one aspect of the present disclosure, change in wheel speed changes speed or position of an active mass, that consequently provides energy for driving an air pump, that may simultaneously or non-simultaneously inflate the wheel tire.

In one embodiment, an active mass is arranged to move radially during change of wheel speed. Thus, the movement may directly inflate the wheel or build up mechanical energy or electrical energy to operate the air pump.

In some embodiments, the stored energy may be released during periods of time where either a certain amount of energy is stored, or whenever a sensing system registers that the wheel tire needs inflation, consequently starting the operation of the air pump.

In one embodiment, the active mass is an integral part or directly connected to the air pump, inflating the wheel tire, whenever the wheel is changing speed.

In another aspect of the present disclosure, the movement of the active mass is limited to take place during an interval of wheel speed. Thus, in some embodiments the active mass may start to move directly whenever the wheel is rotating, whereas in some embodiments the movement may only start once a certain rotational speed is reached. In the same manner, the active mass may stop moving once a certain speed of the wheel is reached.

The lower limit may be between 0 and 50 km/h of the vehicle, and the upper limit between 20 km/h and 100 km/h of the vehicle. The lower limit for practical reasons is always below the upper limit, to ensure that the mechanism is activated.

In some embodiments, the upper limit may be adjustable by other features, not described further in detail, but controlling the interval depending upon driving conditions or weather conditions.

In yet other aspects of the present disclosure, the mechanism may be integral or adaptable to the wheel rim, e.g. being part of the rim structure.

In some embodiments, the mechanism may be adaptable to the rim of the wheel, either positioned inside the rim or being attachable to the outside of the rim.

In one preferred embodiment, the mechanism is integral with the rim.

In another aspect of the invention, the mechanism is not directly integral or adaptable with/to the rim, but mounted together with the rim, e.g. using the same wheel bolts as the rim. In such an embodiment, the mechanism may have its own structure independent of the rim structure.

In yet another aspect of the invention, the mechanism may be directly adaptable to the tire or parts thereof, including the inlet valve. In other embodiments the mechanism may be positioned inside the tire, either as an individual component, or as a component attached to the tire or even being part of the tire.

In another aspect, the mechanism is connected or adapted to a valve that helps limiting the pressure of air inside the wheel. In some embodiments, the valve is a bleed valve, that simply releases air once an upper bound or threshold of pressure is exceeded, and in other embodiments the mechanism is configured to stop inflation when a certain pressure inside the tire is reached, simply eliminating function of the air pump.

In the said limitation, the pressure may be adjustable by other means, not described in detail, but e.g. an electronical operated bleed valve that is adjustable by a wireless connection between the vehicle computer system and the valve.

In yet another aspect of the system, the air let into the tire by the air pump, is filtered, ensuring particles and undesirable substances are not pumped into the tire or into the pressure regulating system during operation of the air pump.

### DESCRIPTION OF THE DRAWINGS

The exemplary embodiments will hereinafter be described in conjunction with the following drawing figures, wherein like numerals denote like elements, and wherein:

FIGS. 1a to 1c show schematic diagrams of a vehicle wheel including a tire inflation mechanism, in accordance with various embodiments;

FIG. 2 is a cross-sectional view of a vehicle wheel including a tire inflation mechanism, in accordance with various embodiments; and

FIG. 3 is a schematic diagram of a tire inflation mechanism included in a vehicle wheel, in accordance with various embodiments.

### DETAILED DESCRIPTION

The following detailed description is merely exemplary in nature and is not intended to limit the application and uses.

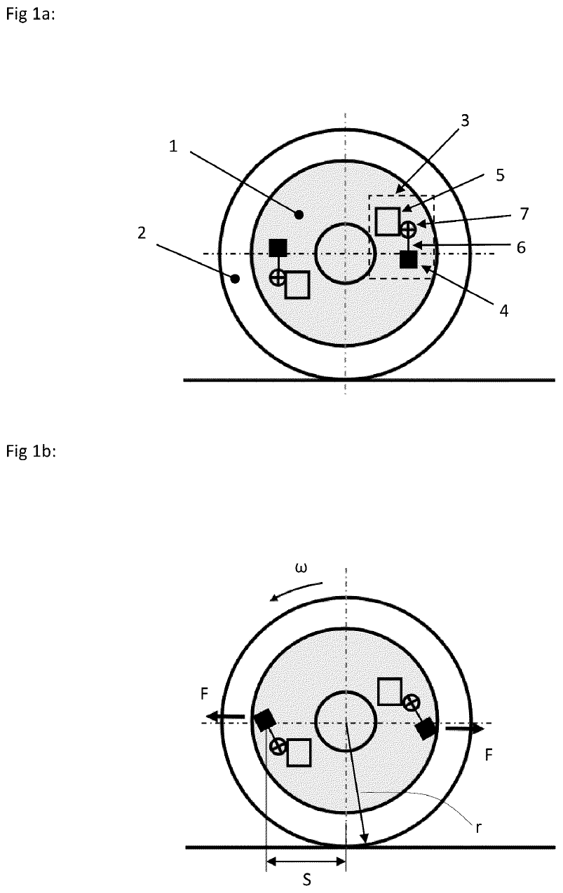

In FIGS. 1a to 1c, embodiments of the present disclosure are schematically illustrated. Referring to FIGS. 1a to 1c, a vehicle rim 1 is configured with a tire 2 along the periphery. Together the rim and the tire form a wheel of a vehicle (not illustrated). The vehicle may be used to transportation of people, animals or goods in general. The wheel may be part of a vehicle used for driving on a road, off-road or at working/production sites. The vehicle may further be manually controlled or autonomous.

In the rim 1, a tire inflation mechanism 3 is included. The tire inflation mechanism 3 includes an active mass 4 and an air pump 5. The active mass 4, with the mass of m, may in one exemplary embodiment be fixed to the rim 1 by using an arm 6 and a pivoting fixation 7, allowing the active mass 4 positioned at the end of the arm 6 to move radially by pivoting around the pivoting fixation.

In the example of FIG. 1a, the tire inflation mechanism 3 is integral with the wheel and is illustrated during a period of time when the wheel is standing still. Thus, the active mass 4 is positioned in a resting position.

In FIG. 1b, the wheel has started rotating as the vehicle has started moving. The wheel having a rolling radius of r, may rotate with a certain angular speed ω influencing the active mass m with centrifugal forces according to equation 1 below:

F=m×r×ω² (equation 1)

The active mass 4 may consequently move outwards radially as influenced by the radial centrifugal forces. The distance from the center of rotation of the wheel—S—may thus be increased. During movement, the active mass 4 may perform a work W, that is fully or partly feeding the operation of the air pump 5.

In one embodiment, the tire inflation mechanism 3 is directly connected to the air pump 5. Thus, during movement of the active mass, the tire 2 is inflated.

In one configuration of the tire inflation mechanism 3, the active mass 4 starts to move at a certain lower speed of the vehicle V_{lower}. Further, in one embodiment, the active mass 4 stops moving once a certain upper speed Vᵤₚₚₑᵣ is reached. Thus, in some embodiments, the inflation of the tire 2 may start immediately once V_{lower} is exceeded and stop again once Vᵤₚₚₑᵣ is reached. In other embodiments, the buildup of energy or pressure starts at V_{lower}, but inflation takes place sometime in between V_{lower} and Vᵤₚₚₑᵣ, depending on different parameters.

To serve as an example V_{lower} may be 20 km/h and Vᵤₚₚₑᵣ 80 km/h for a passenger car. The range may be chosen to ensure that the active mass in the mechanism is always reset to a certain well-known position e.g. by a biasing member such a mechanical spring. It is seldom that passenger cars are driven mainly below 20 km/h and given a Vᵤₚₚₑᵣ of 80 km/h—95% of the work the active mass may perform is represented in the interval 20 km/h to 80 km/h. Choosing Vᵤₚₚₑᵣ to be 80 km/h may be based on the observation that passenger cars most of the time accelerate up to 70-80 km/h, said acceleration is the basis of energy created. A mechanism depending on higher speed may not work properly in all passenger cars mainly driven to maximum 80 km/h. Further having a Vᵤₚₚₑᵣ limited, could help limiting unbalances created by minor positioning errors in a doubled/mirrored mechanism, as shown in FIG. 1a. In, particular at higher speed as the forces acting on two active masses increase quadratically to the rotation speed. Any positioning error—meaning the radial distance of the two active masses are not the same, would generate unequal radial forces, thus providing oscillations or shakings of the wheel. The lower and upper limits may be defined by a biasing force (e.g. a spring) acting on the active mass 4 and a stop, respectively.

Even though it is understood that said balancing of the wheel during operation, by ensuring that two active masses are positioned mirrored to the center of the wheel, and with equal distance during operation or resting, other configurations may also be applicable. Thus, the active masses may be different, and the position or movement may differ during operation, still obtaining a balanced wheel. For vehicles never exceeding or reaching high speeds, the balancing of the wheel may be much less important, and configurations of different kinds may be more applicable.

In one preferred embodiment, the mechanism is doubled, tripled or even repeated up to 100 times in the wheel, as the mechanism may be very small and designed as an integral mechanism, e.g. of plastic or aluminum cut out or molded.

Further in some preferred embodiments, one single air pump may be driven by two or more active masses, as these are interlinked to each other or the air pump.

In other preferred embodiments, one biasing member may be active in two or more mechanisms ensuring equal biasing force applied to all mechanisms.

In one preferred embodiment, the active member is driving one air pump, that is connected directly to the tire, inflating air as the active mass is moving during acceleration of the wheel. Multiple mechanisms are therefore connected individually to the same tire reservoir or individual reservoirs of the tire, being inflatable individually. Such tires could hold circumferential compartments, isolated from one another, but each one inflatable.

In another embodiment, at least two air pumps are connected in series powered by at least two tire inflations mechanisms with an active mass, so that the outlet from one is providing an inlet for another. This may be interchangeable during operation by means not disclosed, or it may be configured during mounting or during manufacturing/assembly of the tire inflation mechanisms. Thus, different maximum air pressures may be addressed without giving call to volume at lower pressures or maximum speeds.

In a preferred embodiment shown in FIG. 1c, a biasing member 8 is shown included in the tire inflation mechanism 3. The biasing member, which is shown for each of the two tire inflation mechanisms 3, may be a mechanical spring, a pneumatic device, magnetic actuator/spring or even an electronic resetting actuator powered by means not described within here. For all the mentioned means, the force they apply is understood to be less than at least what the active mass m exerts during operation at Vᵤₚₚₑᵣ, and potentially also at V_{lower}. Said biasing member helps to reset the mechanism once the wheel is rotating with less than V_{lower}.

In one embodiment, the biasing member force may also be used to drive the air-pump. Thus, in some embodiments, the air-pump is operating and inflating the tire both during acceleration and deceleration, or solely during deceleration, as energy built up in e.g. the biasing member is released during deceleration.

When driving on roads, the wheel encounters numerous small bumps and vibrations. These can cause the free masses (like the active mass in the mechanism) to move unpredictably or oscillate, potentially leading to inconsistent or unintended operation of the air pump. In some embodiments, a damping element may be included to perform a damping function on movement of the active mass or the damping function may be provided by the biasing member to help stabilize these movements, ensuring that the active mass only moves as intended in response to changes in wheel speed, not due to road vibrations. In some examples, a fluid (like a viscous oil) is provided to dampen the movement of the active mass within the tire inflation mechanism. The resistance created by the fluid's viscosity helps to stabilize the motion of the active mass, reducing the impact of rapid or minor vibrations caused by the road surface. For example, a damping chamber may be included in the tire inflation mechanism filled with a viscous fluid where the active mass is located. This chamber would be part of, or connected to, the biasing member (e.g., a spring). In another example, the active mass could be attached to a piston that moves within a cylinder filled with viscous fluid. As the active mass moves, the piston moves through the fluid, which provides the damping effect.

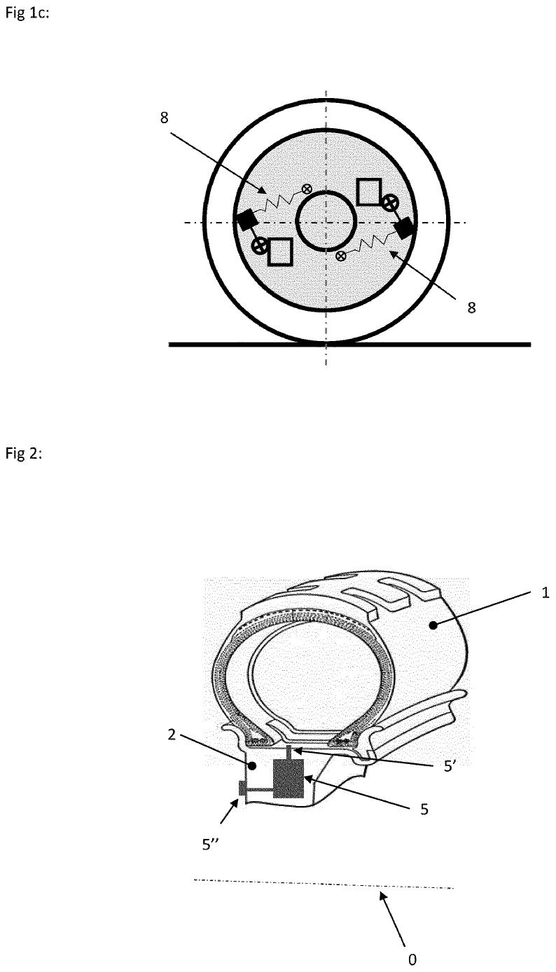

In FIG. 2, another exemplary embodiment of the present disclosure is illustrated, in which the outlet from the air pump 5 is connected to the inside of the tire 1. The air-pump 5 is integral or mounted within/to the rim 2 of the vehicle wheel, with an outlet 5′ adapted to inflate the tire inside the space between the rim and the tire. The rim being rotatable around the center axis 0.

Further the air-pump may be adapted with an inlet 5″ also comprising filtering means, to reduce or eliminate particles being sucked into the air-pump 5 and dispersed inside the tire. The filter may, apart from reducing or eliminating air-born particles, also reject water, and even be able to dry out the inlet air from moisture or vapors to avoid build up of e.g. condensed water inside the tire.

In some embodiments, the air-pump 5 is adapted to only deliver the right pressure for the tire, e.g. by a mechanism limiting the upper pressure during inflation. Such limitation may happen by using a bleed valve, that allows air to be released once the upper pressure is reached. In other embodiments, the air-pump 5 may be configured to decouple the tire inflation mechanism 3 once the maximum pressure is reached. In both the said cases, the active mass m is allowed to move into a predetermined position corresponding to Vupper.

In yet other embodiments, multiple tire inflation mechanisms 3 may be coupled to each other, and the air-pump 5 is adapted to stop further movement of the tire inflation mechanisms 3 once the desired pressure inside the tire is reached. Such blocking could be done by simple ordinary mechanical means such as a mechanical stop being activated once the desired pressure inside the tire is reached. Thus, if multiple tire inflation mechanisms are blocked simultaneously, the risk of creating unbalance in the wheel is limited.

In some embodiments, the volume of the air-pump is adapted to different needs for inflation. In some embodiments the air-pump is adapted to fill in only a minor fraction of total volume of air in the tire. Thus, for this purpose, the tire inflation mechanism is merely an auxiliary device, ensuring that the tire is always inflated despite minor leaks or changes in the atmospheric pressure or ambient temperature. In other embodiments, the tire inflation mechanism inflates a much higher fraction of air in comparison to the volume of the tire. Thus, for one embodiment, the air pump, or the sum of air pumps, in one wheel are sufficient to inflate the tire fully.

For embodiments where the volume of air inflated at each sequence of air inflation or wheel acceleration is only a minor fraction of the total volume comprised in the tire, the fraction of air inflated during one cycle from Vlower to Vupper, may be in between 1/10000 to 1/100 of the total volume of the tire. This will ensure that minor leaking of the tire is always compensated. Sudden changes in e.g. load of e.g. a passenger car by adding additional passengers may not be compensated for promptly and possibly requires multiple sequences of acceleration or deceleration.

For other embodiments, the fraction of air may be as high as 1, meaning that the tire inflation mechanism inflates the whole tire in one sequence of acceleration from e.g. 0 km/h to 50 km/h. This could be used in applications where the tire is almost airless, or very thin comprising a relatively small volume of air. One example could be autonomous vehicles used seldomly, where there is no guarantee that the air can be kept in the tire for longer periods, and one start stop sequence will be enough to ensure proper tire pressure.

For other embodiments, the fraction of air inflated into the tire may be 1/100 to ½ of the total volume inside the tire, allowing for rapid change in air pressure e.g. depending on driving conditions for the vehicle.

It must be understood, that even though, the above description refers to a relatively simple mechanical design, electronic control and electronic communication may also be included. Thus, the said valve for limiting or deciding if the air pump should pump air into the tire, may be controlled by electronics, communicating with a control-system of the vehicle. This may be wireless, and there may even be power supply on board the wheel, to ensure that the electronics can operate.

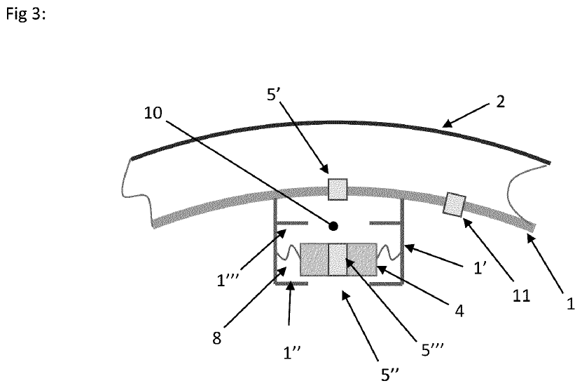

FIG. 3 illustrates another preferred embodiment of the invention, in which the active mass 4 is suspended by a biasing member 8, which also serves as a seal between a compression chamber 10 and the inlet 5″. Part of the rim is forming a housing 1′ for comprising the active mass 3 and the biasing member 8. Thus, the housing 1′ may also form starting and ending points for the movement of the active mass. During rest, or stillstand of the wheel, the active mass 4 may be forced to rest on a lower stop 1″ by the biasing member 8, and, during operation, once Vupper is reached, rest on an upper stop 1′″. Thus, during operation, the active mass 4 may wander or move in between the two stop positions, and compress air in the compression chamber 10. Once the pressure in the compression chamber reaches a pressure higher than inside the tire, the valve 5′ opens and lets air into the tire. A bleed valve 11 is adapted to ensure that the pressure inside the tire does not exceed the recommended value.

In some embodiments, the bleed valve 11 may be integral with the tire inflation mechanism, being connected to the compression chamber. Further, the valve may be electronically controlled such that the level of pressure where the valve opens is adjustable e.g. from an outside control source.

During operation, the active mass rests on or is limited by the stop 1″, biased by the biasing member 8, which is in the form of a membrane in the exemplary embodiment. Once the wheel of the vehicle starts to rotate, and a Vlower of the vehicle is reached, the active mass 4 is moved radially outwards due to centrifugal forces. The forces work against the biasing member and the pressure building up in the compression chamber 10. Once the pressure in the compression chamber 10 exceeds the pressure in the tire, air is inflated into the tire, and the active mass may continue to move until being stopped at 1′″.

The bleed valve 11 ensures that the recommended value of pressure is kept below the recommendation.

During deceleration of the wheel, the active mass returns to the initial position, filling the compression chamber with new air, through the valve 5′″, while the valve 5′ is sealed, being a one way valve only allowing air to flow from the compression chamber 10 to the tire.

In some embodiments, the bleed valve 11 is a simple valve, comprising a ball pressed towards a sealing by a biasing spring. Once the pressure acting on the ball exceeds the value that the assembly is adapted to, the ball releases its sealing, and lets air out. Such bleed valve designs are well-known, and can be made precise, even during changing temperature conditions (e.g. by the spring being made of material that is less sensitive to change modulus as a consequence of temperature). In some embodiments, the bleed valve 11 may be more sophisticated, comprising more elements, to compensate for changes in temperature. Thus, for one embodiment, the bleed valve 11 is designed with a temperature compensating mechanism, that ensures a high precision pressure regulation in a huge temperature interval e.g. −20 degrees Celsius to +60 degrees Celsius.

Even though the presented preferred embodiments, may comprise solutions, in which the compression of air takes place simultaneously with the movement of the active mass, this may in other embodiments not be the case.

Thus, in embodiments not described further into details, there may be a delay between when the air pump is active and when the active mass produces energy for driving the compression of air and inflation. In one embodiment, the active mass builds up kinetic energy during acceleration of the wheel so that once certain conditions happen, which could be speed of the vehicle, the energy is transferred into compression of air.

In another embodiment of the invention the air pump is connected to a secondary reservoir, smaller than that of the tire volume, but working as an intermittent storage of compressed air, which is then, once conditions are satisfied, operated to inflate the tire. Such a reservoir may be relatively small, but the air pump is then adapted to store air under much higher pressure than what the tire requires e.g. between 5 bar and 200 bar. A valve mechanism may be adapted to work between the ambient pressure and the tire pressure, to activate inflation from the reservoir into the tire if tire pressure becomes too low. In such an example, a bleed valve is only needed to ensure that tire pressure does not become too high during change of ambient temperature or ambient pressure. In some cases. the bleed valve is not needed at all, accepting that the tire pressure becomes too high, but never too low.

It should be understood that various changes can be made in the function and arrangement of elements without departing from the scope of the disclosure as set forth in the appended claims and the legal equivalents thereof.

1. A tire inflation mechanism for intermittent inflation of a vehicle wheel tire, comprising:
an active mass configured to change speed or position during change in vehicle wheel speed; and
an air pump configured to inflate a tire of the vehicle wheel;
wherein a change in speed of the vehicle wheel causes the active mass to build up energy or exert forces that is used to drive the air pump to inflate the tire,
wherein movement of the active mass is limited to start at a minimal rotational speed of the wheel and stopped at a maximal rotational speed of the wheel, and wherein the maximal rotational speed is in a range that corresponds to 20-100 km/h of a vehicle.

2. The tire inflation mechanism according to claim 1, wherein the active mass is adapted to change radial distance with respect to a center of the wheel during change of wheel speed.

3. The tire inflation mechanism according to claim 2, wherein the active mass is adapted so that as the active mass changes radial distance to the center of the wheel, the active mass causes simultaneous inflation of the wheel tire.

4. The tire inflation mechanism according to claim 2, wherein the active mass is adapted so that as the active mass changes radial distance to the center of the wheel, the active mass causes buildup of energy mechanically to inflate the tire timewise independent of the movement of the active mass.

5. The tire inflation mechanism according to claim 1, wherein a lower limit and an upper limit of the range are defined by a biasing force acting on the active mass and a stop, respectively.

6. (canceled)

7. The tire inflation mechanism according to claim 1, wherein the mechanism is adaptable to a rim of the wheel.

8. The tire inflation mechanism according to claim 1, wherein the tire inflation mechanism is integrated with a rim of the wheel.

9. The tire inflation mechanism according to claim 1, wherein the tire inflation mechanism is configured to be adapted to an inside of a tire of the wheel or in connection with an air valve used to pre-inflate the wheel.

10. The tire inflation mechanism according to claim 1, wherein the tire inflation mechanism includes a valve that limits a tire pressure.

11. The tire inflation mechanism according to claim 1, wherein the air pump is associated with a filter that prevents particles, moisture, or vapors to enter the tire during inflation by the air pump.

12. A tire inflation mechanism associable with a vehicle wheel, comprising:
an active mass arranged to move under centrifugal force when the vehicle wheel rotates to pump air in a tire of the vehicle wheel,
wherein movement of the active mass is limited to start at a minimal rotational speed of the wheel and stopped at a maximal rotational speed of the wheel,
wherein the active mass is mechanically linked to an air pump to power the air pump to pump air in the tire of the vehicle wheel, and
wherein the maximal rotational speed is in a range that corresponds to 20-100 km/h of the vehicle.

13. The tire inflation mechanism according to claim 12, wherein the tire inflation mechanism is connectable to a rim of the vehicle wheel.

14. The tire inflation mechanism according to claim 12, wherein the active mass is comprised within the air pump and forms a piston thereof.

15. (canceled)

16. The tire inflation mechanism according to claim 12, comprising a one-way valve between the air pump and the tire to allow air into the tire and prevent air returning from the tire.

17. The tire inflation mechanism according to claim 12, comprising a one-way valve allowing air to be pumped into the tire and preventing air returning from the tire.

18. The tire inflation mechanism according to claim 12, comprising a bleed valve to prevent over inflation of the tire.

19. A rim for a vehicle wheel comprising the tire inflation mechanism of claim 1.

20. A vehicle wheel comprising a rim, and the tire and the tire inflation mechanism of claim 12.
